(19) United States
(12) Patent Application Publication
(10) Pub. No.: US 2013/0232003 A1
(43) Pub. Date: Sep. 5, 2013

(54) ADVERTISEMENT SYSTEM USING MOTION DETECT ILLUMINATION

(71) Applicant: EXCREATIVE CO., LTD., Seoul (KR)

(72) Inventor: Chang-Hwa YEO, Busan (KR)

(73) Assignee: EXCREATIVE CO., LTD., Seoul (KR)

(21) Appl. No.: 13/781,779

(22) Filed: Mar. 1, 2013

(30) Foreign Application Priority Data
Mar. 2, 2012 (KR) 10-2012-0022004

(51) Int. Cl. G06Q 30/02

(52) U.S. Cl. CPC G06Q 30/0251
USPC 705/14.49

(57) ABSTRACT

An advertisement system capable of providing an effective advertisement message by attracting the public's attention and increasing the recognition of the advertisement product is shown. The advertisement system includes motion detect sensors disposed at regular intervals along a railing of a structure to detect pedestrian motion, control parts respectively connected to each of the motion detect sensors, each control part receiving a motion detect signal from the associated motion detect sensor that detects the pedestrian motion, and an advertisement module connected to the control parts to display phrases along a longitudinal direction of the railing, the advertisement module providing an illumination to an advertisement phrase or a public service phrase that is near the pedestrian by control of a control part having received the motion detect signal from the motion detect sensor to guide the pedestrian's attention to the advertisement phrases or the public service phrases.

### CROSS REFERENCE TO RELATED APPLICATION

This application claims priority from and the benefit of Korean Patent Application No. 10-2012-0022004 filed on Mar. 2, 2012, which is hereby incorporated by reference for all purposes as if fully set forth herein.

### BACKGROUND OF THE INVENTION

1. Field of the Invention

Exemplary embodiments of the present invention relate to an advertisement system, more particularly the exemplary embodiments of the present invention relate to an advertisement system that is operated by detecting movement of a pedestrian or vehicle to provide advertisement to the public by using a motion detect illumination.

2. Discussion of the Background

In general, a sign is kind of a cover used by stores, company, or facilities to attract people's attention by using name, product names, business item, it may be classified by where it is installed such as a rooftop signage, wall sign, projecting sign, storefront signage, standing signboard, or a bill board that is located in hills, mountain, or highway, or it may be classified by its structure such as a neon sign, ad pillar, picture sign, plastic sign or a cine sign, etc.

The illumination advertising sign provides an advertisement message in a lightened state that results the public to not know the differences between the nearby advertisements resulting less attraction to the public.

In addition, since the illumination advertisement was turned-on for a long period of time causing to consume a lot of power and pollution environment with illumination.

### SUMMARY OF THE INVENTION

The present invention is to provide an advertisement system that attracts the public's attention and increases the recognition of the advertisement by effectively providing the public with the advertisement message.

The present invention also provides an advertisement system that reduces maintenance cost and illumination pollution by effectively using energy.

The present invention also provides an advertisement system that increases the safety of the visually impaired by providing walking guidance and direction guidance.

An advertisement system includes a plurality of motion detect sensors disposed at regular intervals along a railing of a structure such as a bridge, an overhead bridge, a stairway, or an escalator to detect pedestrian motion, a plurality of control parts respectively connected to each of the motion detect sensors, each control part receiving a motion detect signal from the associated motion detect sensor that detects the pedestrian motion, and a plurality of control parts respectively connected to each of the motion detect sensors, each control part receiving a motion detect signal from the associated motion detect sensor that detects the pedestrian motion, and an advertisement module connected to the control parts to display advertisement phrases or public service phrases along a longitudinal direction of the railing, the advertisement module providing an illumination to an advertisement phrase or a public service phrase that is near the pedestrian by control of a control part having received the motion detect signal from the motion detect sensor to guide the pedestrian's attention to the advertisement phrases or the public service phrases.

For example, the advertisement module may include a plurality of LED modules respectively connected to each of the control parts to be on or off according to receiving states of the motion detect signals of the control parts, at least one cover disposed along the longitudinal direction of the railing to receive the LED modules, and at least one advertisement film attached to the cover, the advertisement phrase or the public service phrase being written on the advertisement.

For example, the control parts may control on and off of a LED module corresponding to a location motion-detected by the motion detect sensor. In addition, the control parts may control on and off of a LED module corresponding to a predetermined distance away from a location motion-detected by the motion detect sensor.

In addition, the advertisement module may include a display part connected to each of the control parts to display the advertisement phrases or the public service phrases according to receiving states of the motion detect signals of the control parts and at least one cover disposed along the longitudinal direction of the railing to receiving the LED module inside.

An exemplary embodiment of the present invention includes a plurality of height sensors installed at regular intervals at the cover to detect an object that passes the upper part of the cover, a control part connected to each of the height sensors to receive a detect signal from the height sensors, and a message passing means that passes out a message by the control part having received the detect signal from the height sensors.

In addition, the advertisement system may further include a camera part that is installed at regular intervals at the advertisement module, a communication part that provides a video signal captured by the camera part to a control center, and a monitor part disposed in the control center to display the captured video that is received from the communication part.

An exemplary embodiment of the present invention includes a plurality of motion detect sensors disposed at regular intervals along a longitudinal direction of a wall of a structure such as a building or a underground passage to detect pedestrian motion, a plurality of control parts respectively connected to each of the motion detect sensors, each control part receiving a motion detect signal from the associated motion detect sensor that detects the pedestrian motion, and an advertisement module connected to the control parts and disposed on a ceiling of the structure, the advertisement module providing an illumination from the ceiling toward a predetermined area of a bottom of the structure that is front of a walking direction of the pedestrian to display an advertisement phrase or a public service phrase by control of a control part having received the motion detect signal from the motion detect sensor, to guide the pedestrian's attention to the advertisement phrases or the public service phrases.

In addition, the advertisement module may include a plurality of LED modules respectively connected to each of the control parts to be on or off according to receiving states of the motion detect signals of the control parts, at least one cover disposed along the longitudinal direction of the railing to receive the LED modules, and at least one advertisement film attached to the cover, the advertisement phrase or the public service phrase being written on the advertisement. Furthermore, the advertisement module may include a plurality of speaker parts respectively connected to each of the control parts to provide a message according to receiving states of the motion detect signals of the control parts.

An exemplary embodiment of the present invention includes a plurality of motion detect sensors disposed at regular intervals along a road such as a bicycle lane to detect motion of a pedestrian or a vehicle, a plurality of control parts respectively connected to each of the motion detect sensors, each control part receiving a motion detect signal from the associated motion detect sensor that detects the motion of the pedestrian or the vehicle, and an advertisement module connected to the control parts, the advertisement module providing an illumination towards a predetermined area that is front of a walking direction of the pedestrian or the vehicle to display an advertisement phrase or a public service phrase by control of a control part having received the motion detect signal from the motion detect sensor, to guide the pedestrian's attention and movement to the advertisement phrase or the public service phrase.

In addition, the advertisement module may include a plurality of LED modules respectively connected to each of the control parts to be on or off according to receiving states of the motion detect signals of the control parts, at least one cover disposed along the longitudinal direction of the railing to receive the LED modules, and at least one advertisement film attached to the cover, the advertisement phrase or the public service phrase being written on the advertisement.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a drawing showing an advertisement system which use motion detect illumination according to a first embodiment of the present invention.

FIG. 2 is a drawing describing a process of the advertisement system which use motion detect illumination according to the first embodiment of the present invention.

FIG. 3 is an exploded perspective drawing showing an advertisement system which use motion detect illumination according to an second embodiment of the present invention.

FIG. 4 is a block drawing showing an advertisement system which use motion detect illumination according to a second embodiment of the present invention.

FIG. 5 is a drawing showing an advertisement system which use motion detect illumination according to a third embodiment of the present invention.

FIG. 6 is an exploded perspective drawing showing an advertisement system which use motion detect illumination according to a fourth embodiment of the present invention.

FIG. 7 is a schematic drawing showing an advertisement system which use motion detect illumination according to a fifth embodiment of the present invention.

FIG. 8 is a drawing showing an advertisement module according to a fifth embodiment of the present invention.

FIG. 9 is a schematic drawing showing an advertisement system which use motion detect illumination according to a sixth embodiment of the present invention.

FIG. 10 is a detail drawing showing an advertisement system which use motion detect illumination according to a sixth embodiment of the present invention.

### DETAILED DESCRIPTION OF THE INVENTION

The invention is described more fully hereinafter with reference to the accompanying drawings, in which exemplary embodiments of the invention are shown. However, this invention may be embodied in many different forms and should not be construed as limited to the embodiments set forth herein. Numerical terms such as “one”, “two”, etc. may be used as cardinal numbers to indicate various structural elements, however, the structural elements should not be limited by the terms. The terms are only used to distinguish one structural element from another structural element. For example, a first structural element may be named as second structural element if the right is not beyond the scope, the same applies to the second structural element that may be named as the first structural element.

The terms used in the present application are only to explain the specific embodiment and is not intended to limit the present invention. The terms “a”, “an” and “the” mean “one or more” unless expressly specified otherwise. The terms “including”, “comprising”, etc., are to designate features, numbers, processes, structural elements, parts, and combined component of the application, and should be understood that it does not exclude one or more different features, numbers, processes, structural elements, parts, combined component.

The invention is described more fully hereinafter with reference to the accompanying drawings, in which exemplary embodiments of the invention are shown.

First Embodiment

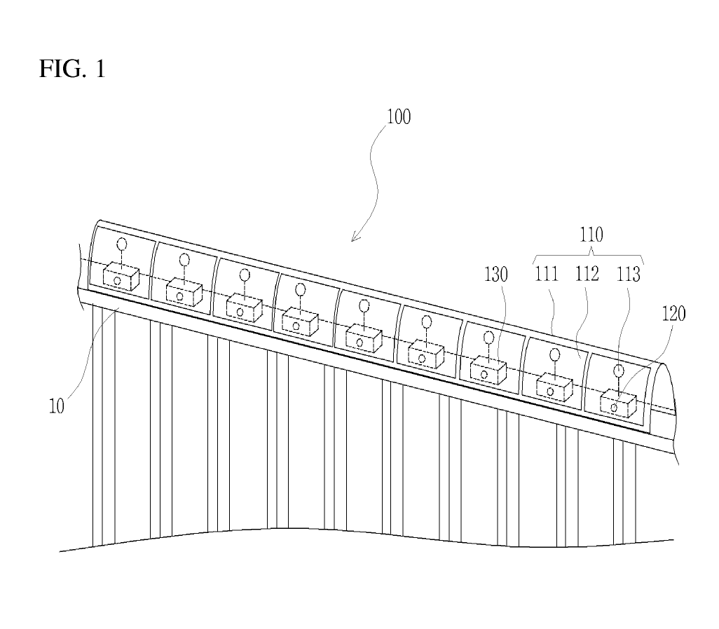

FIG. 1 is a drawing showing an advertisement system which use motion detect illumination according to a first embodiment of the present invention.

Regarding to FIG. 1, an advertisement system 100 which use motion detect illumination according to an first embodiment of the present invention includes an advertisement module 110, a plurality of motion detect sensors 120, and a plurality of control parts 130.

The advertisement module 110 may be installed to a structure having railing For example, a railing or wall surface of a bridge, a stairway, or an escalator. The advertisement module 110 may include at least one cover 111, at least one advertisement film 112, and a plurality of LED modules 113. The cover 111 may be formed in an arch shape and be installed to the railing For example, the cover 111 may be formed of a synthetic resin that has transparency such as a translucent acrylic. The advertisement film 112 is installed to inner side or outer side of the cover 111. For example, the advertisement films 112 may be a transparent film that has an advertisement phrase or public service phrase written on it. The LED modules 113 are connected with the control parts 130 and are disposed inside the cover 111.

The motion detect sensors 120 are disposed inside the cover 110 to have regular intervals along a longitudinal direction of a railing and are connected with a control parts 130 that corresponds to the location of the motion detect sensors. For example, the motion detect sensors 120 is preferred to be an infrared sensor that detects pedestrian or vehicle by using infrared ray.

The control parts 130 are disposed inside the cover and are connected with each of the motion detect sensors 120 and the LED modules 113 which correspond to the location of the control parts. The control parts 130 receives a detect signal of a pedestrian or a vehicle from the motion detect sensors 120 to control the LED module 113 to light the LED module 113 for a predetermined period of time.

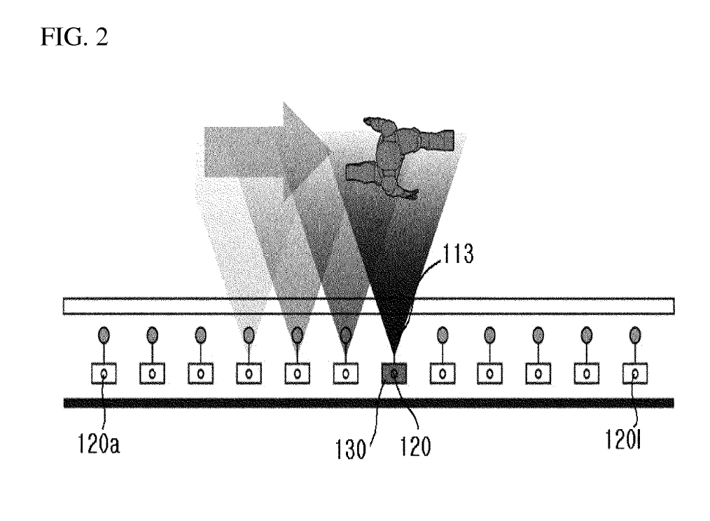

FIG. 2 is a drawing describing a process of the advertisement system which use motion detect illumination according to the first embodiment of the present invention.

Regarding to FIG. 2, when a pedestrian walks from one side to another side along a railing, a pedestrian motion is detected by a motion detect sensor 120a that is located at the one side of a railing towards a motion detect sensor 1201 that is located at the another side of the railing in a sequential direction. The detected signal that is detected by the motion detect sensors 120 are transmitted to the control part 130 that is connected with the motion detect sensor, and the control parts 130 provides a LED module 113 that is connected with each of the control part 130 with a emitting signal to illuminate the LED module 113 that are near to the pedestrian for a predetermined period of time. In other words, the LED module 113 that detects motion starts to illuminate for a predetermined period of time as a pedestrian walks forward, the LED module 113 then sequentially illuminates along the pedestrian walking direction, and the LED module 113 that does not detect any motion starts to sequentially turn-off. Therefore, since the LED module 113 may illuminate when an object is detected, this attracts a pedestrian attention resulting to improve a name-recognition of the advertisement product to maximize the advertisement effect. In addition by reducing power consumption of an unnecessary location may save energy.

Second embodiment

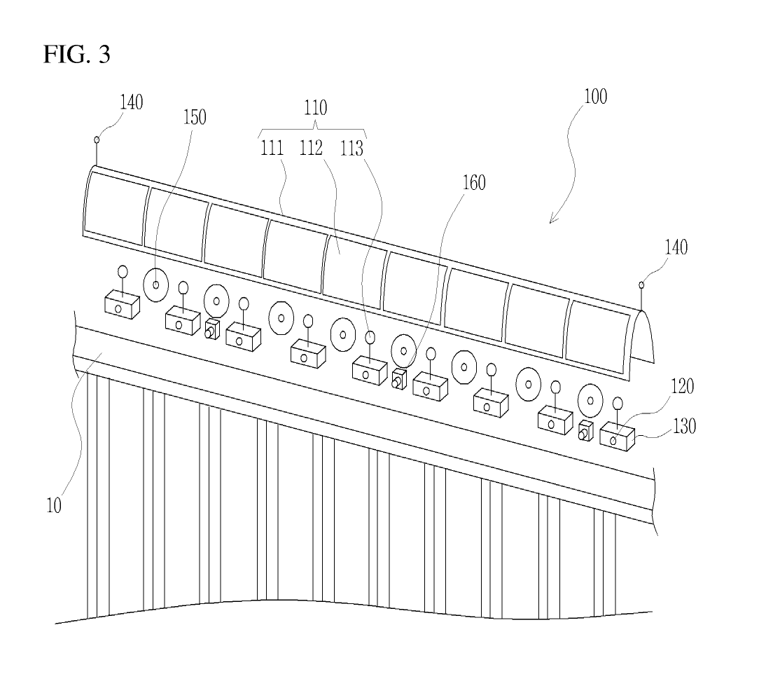

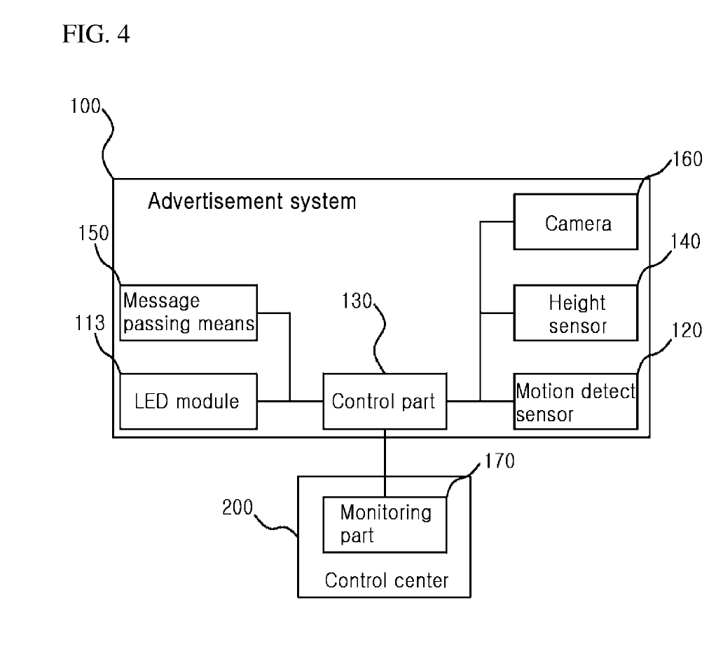

FIG. 3 is an exploded perspective drawing showing an advertisement system which use motion detect illumination according to an second embodiment of the present invention. FIG. 4 is a block drawing showing an advertisement system which use motion detect illumination according to a second embodiment of the present invention.

The advertisement system according to the present embodiment is substantially the same as the advertisement system of the first embodiment except for a height sensor 140, message passing means 150, camera part 160, and a monitoring part 170. Thus, any further description for substantially the same elements as embodiment 1 will be omitted, and the same reference numerals as embodiment 1 will be given to substantially the same elements.

Regarding to FIG. 3 and FIG. 4, the advertisement system according to the second embodiment of the present invention further includes a plurality of height sensors 140 and a message passing means 150. The plurality of height sensors 140 connected with the control parts 130 are installed at regular intervals to the advertisement module 110. The message passing means 150 connected with the control parts 130 provides message by using detect signal that is detected by the height sensors 140. For example, the message passing means 150 may at least use two of a speaker, emergency light, warning light, etc. The message passing means 150 may be connected with a control center 200, and a message may be transferred inside the control center 200 by using the message passing means 150.

The height sensors 140 are used to detect an object that may go over the railing by using a ray such as infrared ray. For example, when someone tries to suicide by climbing over a railing of a bridge, the height sensors may detect the activity and provide a signal to a control center 200. The control center 200 that received a detect signal from the height sensors may send a message through the message passing means 150 to prevent suicide.

In addition, the advertisement system according to the second embodiment of the present invention may further include a camera part 160 and a monitoring part 170. The camera part 160 is installed at regular intervals at the advertisement module 110. The monitoring part 170 may monitor and display the captured images from the camera part 160.

The camera part 160 may be disposed inside or outside of the advertisement module 110. In this regard, a plurality of the camera parts 160 may be disposed at regular intervals along the advertisement module 110. The image captured by the camera 160 is provided to the monitoring part 170 through a control part to be displayed.

The monitoring part 170 may be disposed in the control center 200 to monitor the captured image that is provided from the camera part 200 inside the control center 200. Therefore, when a detect signal is received from the height sensors 140, the control center may identify the situation of the railing to send message through the message passing means 150 or directly contacting the related agencies to prevent accidents.

Furthermore, the advertisement system according to the second embodiment of the present invention may provide a safe moving direction for the pedestrian or vehicle, and also secure vision at the same time. In addition, providing an indirect user that sees the pedestrian with a location of the user through an illumination or a message passing means to prevent traffic accidents, crime prevention effect and suicide prevention effect

Third Embodiment

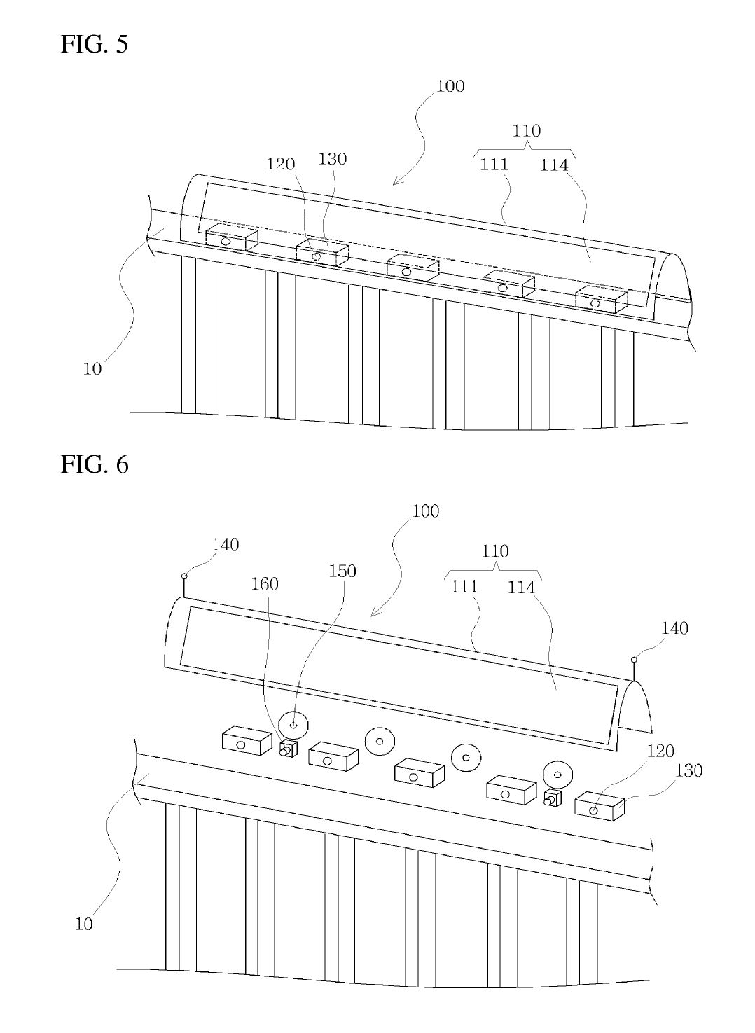

FIG. 5 is a drawing showing an advertisement system which use motion detect illumination according to a third embodiment of the present invention.

The advertisement system according to the present embodiment is substantially the same as the advertisement system of the first embodiment except for a display part 112 replaces an advertisement film 112. Thus, any further description for substantially the same elements as embodiment 1 will be omitted except for the display part 114, and the same reference numerals as embodiment 1 will be given to substantially the same elements.

Regarding to FIG. 5, the advertisement system according to the third embodiment of the present invention includes a display part 114 disposed in the cover. For example, the display part 114 may be one of a LCD monitor, a LED monitor, or a LED electric board.

The display part 114 may only display an advertisement phrases or a public service phrase on the area where a pedestrian motion is detected by the motion detect sensor. In other words, the display part 114 may only display an advertisement phrases or a public service phrase where the moving pedestrian is detected. Therefore, the display part 114 may be interlocked with the pedestrian movement to display advertisement phrases or a public service phrases, this attracts a pedestrian attention resulting to improve a name-recognition of the advertisement product to maximize the advertisement effect. In addition by reducing power consumption of an unnecessary location may save energy. Also, an improved view is provided through an illumination that functions to motion.

Fourth embodiment

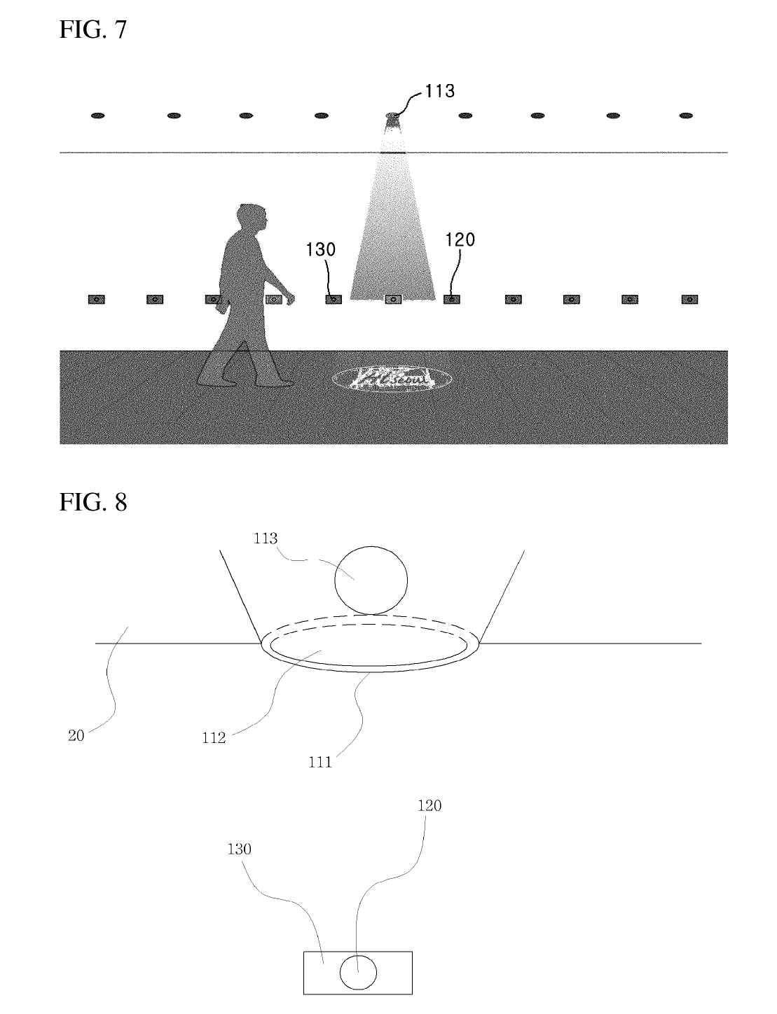

FIG. 7 is a schematic drawing showing an advertisement system which use motion detect illumination according to a fifth embodiment of the present invention.

The advertisement system according to the present embodiment is substantially the same as the advertisement system of the second embodiment except for a height sensor 140, a message passing means 150, camera part 160, and a monitoring part 170 are added. Thus, any further description for substantially the same elements as embodiment 2 will be omitted, and the same reference numerals as embodiment 3 will be given to substantially the same elements.

Regarding to FIG. 6, the advertisement system according to the fourth embodiment of the present invention may further include a height sensor 140, a message passing means 150, camera part 160, and a monitoring part 170 as in the second embodiment of the present invention. The height sensors connected with the control parts 130 are disposed at regular intervals at an advertisement module 110. The message passing means 150 connected with the control parts 130 provides a message by receiving a detect signal that is detected from the height sensors 140. The camera part 160 is installed at regular intervals at the advertisement module 110. The monitoring part 170 disposed in a control center (not shown) may allow an image that is provided from the camera part 160 in the control center.

Fifth Embodiment

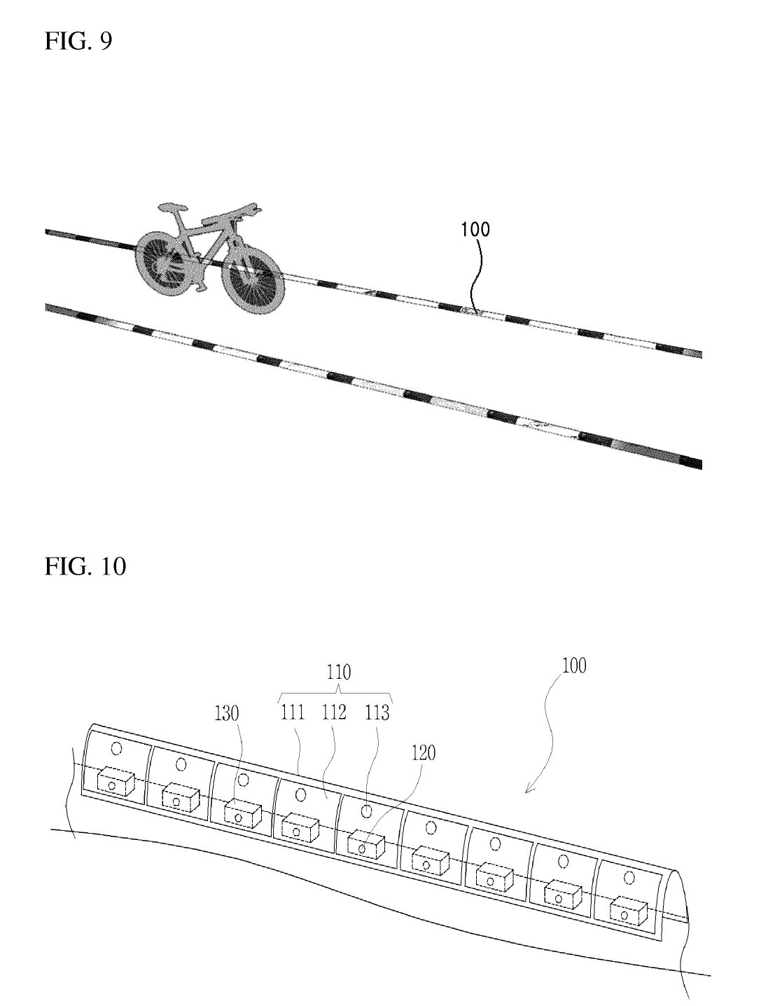

FIG. 8 is a drawing showing an advertisement module according to a fifth embodiment of the present invention. FIG. 9 is a schematic drawing showing an advertisement system which use motion detect illumination according to a sixth embodiment of the present invention.

Regarding to FIG. 7 and FIG. 8, the advertisement system according to the fifth embodiment of the present invention may include a plurality of advertisement modules 110, a plurality of motion detect sensors 120, and a plurality of control parts. The advertisement modules 110 disposed at regular intervals along a ceiling of a building, a tunnel, or an underground passage. The motion detect sensors 120 disposed at regular intervals along the wall of the building, the tunnel, and the underground passage. The control parts 130 are connected with the advertisement modules 110 and the motion detect sensors 120.

The advertisement module 110 includes a cover 111, an advertisement film that is attached to inner or outer side of the cover 111, and the LED module 113 disposed on the ceiling to be located inside the cover 111. The LED module 113 is installed inside the cover. For example, when a motion is detected by the motion detect sensor 120, the control part 130 illuminates a LED module towards front of a pedestrian who is located at the detected location or a predetermined distance from the detected location. Therefore, an advertisement phrase or a public service phrase is displayed at the bottom surface in front of the pedestrian walking direction, this attracts a pedestrian attention resulting to improve a name-recognition of the advertisement product to maximize the advertisement effect and also provide safety to the pedestrian by providing directions and walking passages.

Moreover, the advertisement system according to the fifth embodiment of the present invention may further include a plurality of speakers (not shown) that are connected with the control part 130. The speakers are disposed at regular intervals along a ceiling or a wall, and when a motion is detected by the motion detect sensors 120 a message that is previously recorded by the control parts is provided to a pedestrian, which will increase the safety of the visually impaired.

Sixth embodiment

FIG. 9 is a schematic drawing showing an advertisement system which use motion detect illumination according to a sixth embodiment of the present invention. FIG. 10 is a detail drawing showing an advertisement system which use motion detect illumination according to a sixth embodiment of the present invention.

The advertisement system according to the sixth embodiment is substantially the same as the advertisement system of the first embodiment except for the install location and usage of the advertisement system. Thus, any further description for substantially the same elements as embodiment 1 will be omitted, and the same reference numerals as embodiment 1 will be given to substantially the same elements.

Regarding to FIG. 9 and FIG. 10, the advertisement system according to the sixth embodiment of the present invention includes an advertisement modules 110, a plurality of motion detect sensors 120, and a plurality of control parts.

The advertisement modules 110 may be installed both sides of a bicycle lane. The advertisement modules 110 may be at least one cover 111, at least one advertisement film 112, and a plurality of LED modules 113. The cover 111 may be formed in an arch shape. For example, the cover 111 may be made of a synthetic resin that has transparency such as a translucent acrylic and made of a material that may endure the weight of the bicycle and the pedestrian to protect the LED modules 113, the motion detect sensor 120, and the control parts 130 which are installed inside the cover.

The motion detect sensors 120 are disposed inside the cover 110 to have regular intervals along a longitudinal direction of a bicycle lane.

The control parts 130 are disposed inside the cover and are connected with each of the motion detect sensors 120 and the LED modules 113 which correspond to the location of the control parts.

The function of the sixth embodiment of the present invention is explained as follow. Regarding to FIG. 9 and FIG. 10, the LED module 113 may illuminate a location where a motion is detected by the motion detect sensor 120 and a location where it is a predetermined distance away from the detected location at once to guide the bicycle process direction, and to provide advertisement by using the advertisement film 112.

The advertisement system according to the sixth embodiment of the present invention is a system that is turn-on and off by responding to a motion of pedestrian and vehicle, and it may provide an energy saving effect by using efficient energy usage and a reduce of illumination pollution by replacing constant turned-on lights and advertisement. Furthermore, since the system is installed in both side of the bicycle lane it will provide a leading light for pedestrian or bicycle for safety.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An advertisement system which use motion detect illumination, comprising:
a plurality of motion detect sensors disposed at regular intervals along a railing of a structure such as a bridge, an overhead bridge, a stairway, or an escalator to detect pedestrian motion;
a plurality of control parts respectively connected to each of the motion detect sensors, each control part receiving a motion detect signal from the associated motion detect sensor that detects the pedestrian motion; and
an advertisement module connected to the control parts to display advertisement phrases or public service phrases along a longitudinal direction of the railing, the advertisement module providing an illumination to an advertisement phrase or a public service phrase that is near the pedestrian by control of a control part having received the motion detect signal from the motion detect sensor to guide the pedestrian's attention to the advertisement phrases or the public service phrases.

2. The advertisement system of claim 1, wherein the advertisement module comprises:
a plurality of LED modules respectively connected to each of the control parts to be on or off according to receiving states of the motion detect signals of the control parts;
at least one cover disposed along the longitudinal direction of the railing to receive the LED modules; and
at least one advertisement film attached to the cover, the advertisement phrase or the public service phrase being written on the advertisement.

3. The advertisement system of claim 2, wherein the control parts control on and off of a LED module corresponding to a location motion-detected by the motion detect sensor.

4. The advertisement system of claim 2, wherein the control parts control on and off of a LED module corresponding to a predetermined distance away from a location motion-detected by the motion detect sensor.

5. The advertisement system of claim 1, wherein the advertisement module comprises:
a display part connected to each of the control parts to display the advertisement phrases or the public service phrases according to receiving states of the motion detect signals of the control parts; and
at least one cover disposed along the longitudinal direction of the railing to receiving the LED module inside.

6. The advertisement system of claim 1, further comprising:
a plurality of height sensors installed at regular intervals at the cover to detect an object that passes the upper part of the cover;
a control part connected to each of the height sensors to receive a detect signal from the height sensors; and
a message passing means that passes out a message by the control part having received the detect signal from the height sensors.

7. The advertisement system of claim 1, further comprising:
a camera part that is installed at regular intervals at the advertisement module;
a communication part that provides a video signal captured by the camera part to a control center; and
a monitor part disposed in the control center to display the captured video that is received from the communication part.

8. An advertisement system which use motion detect illumination, comprising:
a plurality of motion detect sensors disposed at regular intervals along a longitudinal direction of a wall of a structure such as a building or a underground passage to detect pedestrian motion;
a plurality of control parts respectively connected to each of the motion detect sensors, each control part receiving a motion detect signal from the associated motion detect sensor that detects the pedestrian motion; and
an advertisement module connected to the control parts and disposed on a ceiling of the structure, the advertisement module providing an illumination from the ceiling toward a predetermined area of a bottom of the structure that is front of a walking direction of the pedestrian to display an advertisement phrase or a public service phrase by control of a control part having received the motion detect signal from the motion detect sensor, to guide the pedestrian's attention to the advertisement phrases or the public service phrases.

9. The advertisement system of claim 8, wherein the advertisement module comprises:
a plurality of LED modules respectively connected to each of the control parts to be on or off according to receiving states of the motion detect signals of the control parts;
at least one cover disposed along the longitudinal direction of the railing to receive the LED modules; and
at least one advertisement film attached to the cover, the advertisement phrase or the public service phrase being written on the advertisement.

10. The advertisement system of claim 8, wherein the advertisement module comprises:
a plurality of speaker parts respectively connected to each of the control parts to provide a message according to receiving states of the motion detect signals of the control parts.

11. An advertisement system which use motion detect illumination, comprising:
a plurality of motion detect sensors disposed at regular intervals along a road such as a bicycle lane to detect motion of a pedestrian or a vehicle;
a plurality of control parts respectively connected to each of the motion detect sensors, each control part receiving a motion detect signal from the associated motion detect sensor that detects the motion of the pedestrian or the vehicle; and
an advertisement module connected to the control parts, the advertisement module providing an illumination towards a predetermined area that is front of a walking direction of the pedestrian or the vehicle to display an advertisement phrase or a public service phrase by control of a control part having received the motion detect signal from the motion detect sensor, to guide the pedestrian's attention and movement to the advertisement phrase or the public service phrase.

12. The advertisement system of claim 11, wherein the advertisement module comprises:
a plurality of LED modules respectively connected to each of the control parts to be on or off according to receiving states of the motion detect signals of the control parts;
at least one cover disposed along the longitudinal direction of the railing to receive the LED modules; and
at least one advertisement film attached to the cover, the advertisement phrase or the public service phrase being written on the advertisement.
